(19) United States
(12) Patent Application Publication
(10) Pub. No.: US 2013/0098503 A1
(43) Pub. Date: Apr. 25, 2013

(54) Mobile log splitter and pivoting conveyor: two-in-one

(71) Applicant: Louis Martin Shaeffer, Hampstead, MD (US)

(72) Inventor: Louis Martin Shaeffer, Hampstead, MD (US)

(73) Assignee: Louis Martin Shaeffer, Hampstead, MD (US)

(21) Appl. No.: 13/507,734

(22) Filed: Jul. 25, 2012

Related U.S. Application Data
(60) Provisional application No. 61/627,846, filed on Oct. 20, 2011.

(51) Int. Cl. B27L 7/06

(52) U.S. Cl. 144/195.1

(57) ABSTRACT

A log splitter machine featuring a steel beam upon which an engine, a hydraulic fluid reservoir, a hydraulic cylinder, a splitting ram, and a splitting head are positioned in such a way as to accomplish the task of reducing large sections of logs into smaller pieces. Additional components include a log lifter device, a telescoping rear foot, and a conveyor mechanism. The conveyor mechanism is connected to the frame of the machine by means of a hinge. The machine has both a non-operational position and an operational position. The operational position is achieved by pivoting the conveyor mechanism through an angle of one-hundred eighty degrees around the hinge. In both its non-operational and operational positions, the machine sits upon wheels, allowing for quick and easy relocation.

CROSS-REFERENCE TO RELATED APPLICATIONS

| | | |
|---|---|---|
| 5,022,445 | June, 1991 | Holestine |
| 4,615,366 | October, 1986 | Scarbrough, Jr. |
| 4,481,988 | November, 1984 | Watson, et al. |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of Endeavor

The present invention pertains to the general field of log splitters, more specifically to those log splitters which are of a horizontal orientation, wherein a hydraulically powered splitting ram is utilized for the purpose of forcing a log section through one or more splitting blades.

2. Prior Art

Many variations of horizontally oriented log splitters have been developed over time, however nearly all of them feature the same conceptual design. This design generally consists of a steel beam upon which an engine, a hydraulic fluid reservoir, a hydraulic cylinder, a splitting ram, and a splitting blade or splitting head are positioned. The process of operating such log splitters typically involves the input of hydraulic fluid from the hydraulic fluid reservoir to the engine, and said engine then forcing said hydraulic fluid into the hydraulic cylinder of the splitting ram. The extension of the hydraulic cylinder forces the splitting ram forward, thus pushing a log section into and through the multiple splitting blades of the splitting head. Often times, the entire log splitter apparatus is mounted upon an axle supplied with wheels, so as to increase the mobility of the machine. Examples of such log splitter devices can be found in U.S. Pat. No. 4,615,366 issued Nov. 13, 1984 to Watson, et al.; and in U.S. Pat. No. 4,481,988 issued Oct. 7, 1986 to Scarbrough, Jr.

One of the general goals of the firewood production process, through use of any log splitter machine, is for the process to be as systematic and efficient as possible. Perhaps the largest source of inefficiency in this process is the occurrence of events which prevent the continual splitting of logs, wherein such events require the operator to stop firewood production in order to alleviate the situation. One such event occurs often when using horizontally oriented log splitters of current design. The event beings to develop as log sections are forced through the splitting head and are consequently reduced into smaller pieces. If these pieces do not immediately fall away from the splitting head, then they are forced away as the next log is moved through the splitting head. Either way, all split pieces must be deposited somewhere other than the immediate vicinity of the splitting head itself. Typically, the effects of gravity cause all split pieces to be deposited on the ground in front of, or to the sides of the splitting head. This often causes a mound of split pieces to develop around the splitting head. The problem occurs when the mound of split pieces has become so large that the splitting head is completely surrounded, leaving no place for newly split pieces to be deposited. At this point, the operation of the machine must cease, otherwise the splitting head and splitting ram will inevitably become jammed. This inundation of the splitting head occurs fairly often, when using horizontally oriented log splitter machines of current design, because the distance between the ground and the base of the splitting head is usually not in excess of two or three feet. Therefore the height of the produced firewood pile need only be slightly higher than two or three feet in order for it to impede the further splitting of logs. When enough firewood has accumulated around the machine to prevent further splitting of log sections, the operator must stop work and either manually clear some of the split wood away from the splitting head, or relocate the entire machine.

There is a method which is often used to decrease the frequency with which the previously described problem occurs. This method involves the employment of a two machine system, one of these machines being the previously described log splitter, and the other being a conveyor machine, wherein said conveyor machine contains its own engine for the purpose of powering the motion of a conveyor belt around two spindles. The conveyor machine is typically positioned in such a way that the lower extent of the conveyor belt is slightly below, but adjacent to the splitting head of the log splitter machine, with the upper extent of the conveyor belt directed upwards and away from the log splitter machine. The invention presented in U.S. Pat. No. 5,022,445 issued Jun. 11, 1991 to Holestine, goes as far as to include an exit conveyor as part of a log splitting system. The conveyor of the Holestine invention will temporarily attach to the splitting head end of a horizontally oriented log splitter machine. The conveyor and the log splitter in the Holestine invention are essentially powered by the same engine because the motion of the conveyor belt is caused by the retracting phase of the splitting ram, wherein said retracting phase is due to the input of pressurized hydraulic fluid from the engine. In both the Holestine invention and the more common system of positioning separately powered log splitter and conveyor machines, all pieces of logs, having first been forced through the splitting blades, will fall directly onto the belt of the conveyor. From here, all pieces of split logs will be carried away by the motion of the conveyor belt until the uppermost extent of the conveyor belt is reached. At this point, said split pieces will be deposited on the ground directly below the uppermost extent of the conveyor belt. Most of the conveyor machines presently used in such two-machine systems are equipped with a hydraulic cylinder, serving the purpose of either increasing or decreasing the vertical distance between the uppermost extent of the conveyor belt and the ground directly below. As the operation of log splitting continues, the pile of newly produced firewood begins to accumulate and heighten under the conveyor. The operator can extend the hydraulic cylinder of the conveyor, thusly heightening the upper end of the conveyor to accommodate for the growth of the firewood pile below. However, once the hydraulic cylinder of the conveyor has been fully extended, the pile of split wood will continue to grow until it eventually inundates the uppermost extent of the conveyor belt. This causes a problem very similar to that which was previously described regarding the growth of a firewood pile around the splitting head of a stand-alone log splitter machine. At this point, no more firewood can be produced due to the lack of a location for depositing such wood. Therefore, the operator's only option is to stop work and begin the rather lengthy process of moving and repositioning both the log splitter machine and the conveyor machine.

When compared to the use of a stand-alone log splitter machine, the combined operation of a log splitter machine and a conveyor machine certainly decreases the frequency with which the system must be relocated, simply because the conveyor allows for a much larger pile of firewood to accumulate before the continued splitting of logs is no longer possible. However, the action of relocating the two machine system is quite time consuming. Assuming, as is typically the case, that both the log splitter machine and the conveyor machine are axle mounted and towable, then a tedious process must be employed in order to reposition the entire system. This process involves first pulling the log splitter machine away from the conveyor, then pulling the conveyor to a new location, and finally pushing the log splitter backwards so as to make the splitting head of the log splitter sufficiently close to the lowermost extent of the conveyor belt. The process requires a significant period of time, as the operator must transport each machine individually to the new location, as well as hitch and unhitch his truck or tractor at least six times. Even the Holestine invention requires the operator to disconnect the conveyor mechanism from the log splitter mechanism, and for each machine to be moved separately in order to relocate the system. The current practice is greatly inefficient as the relocation of two machines requires a large stoppage time in the production of firewood. Therefore a need exists for a single machine, which can accomplish the tasks of both splitting logs and conveying the reduced pieces elsewhere, while being towable as one unit, enabling quick and easy relocation and transportation.

### BRIEF SUMMARY OF THE INVENTION

The claimed invention is in general, a single machine, combining a log splitter of the horizontally oriented type, and a conveyor mechanism. The log splitter component is of conventional design, featuring a steel beam upon which an engine, a hydraulic fluid reservoir, a hydraulic cylinder, a splitting ram, and a multi-bladed splitting head are positioned. In addition, the log splitter is equipped with many of the more modern improvements pertaining to the art. Such improvements include a log lifter device, a telescoping rear foot, and a hydraulic cylinder which adjusts the height of the splitting head. The conveyor component is also of standard conceptual design, featuring an engine, a rubber belt which moves continuously around two spindles, and a hydraulic cylinder which adjusts the height of the conveyor. All of the aforementioned systems are powered through the transmission of hydraulic force through pressurized fluid.

There are two engines and two control panels present in the claimed invention. The two engines are supplied with separate fuel tanks, but share a single hydraulic fluid reservoir. The larger engine pressurizes hydraulic fluid and directs it to the upper control panel. By rotating the levers on the upper control panel, the operator can further direct the pressurized fluid to the hydraulic cylinders of the splitting ram, the log lifter, and the splitting head. Similarly, the smaller engine serves the purpose of pressurizing hydraulic fluid and directing it to the lower control panel. By rotating the levers and switches on the lower control panel, the operator can further direct the pressurized fluid to the hydraulic turbine of the conveyor driveshaft, as well as to the hydraulic cylinder of the rear foot, and to the hydraulic cylinder responsible for heightening the conveyor. All used hydraulic fluid is filtered and returned to the hydraulic fluid reservoir to be recycled through the various hydraulic systems of the machine.

The conveyor and log splitter components are both mounted on the same trailer axle and are thusly towable as one unit. Once the jobsite has been reached, the unit can be unhitched from the towing vehicle by manually extending the front foot through use of a hand crank. After the engines are started, the telescoping rear foot can be extended, giving the machine a fourth point of stationary support. Next, the operator can manually pivot the entire conveyor frame from is resting position on the trailer axle, to its operational position, in line with the rear of the machine. This action is possible because the conveyor frame is hinge-connected to the log splitter frame. Once the conveyor frame has been locked into place by a bolt, the heightening cylinder can be extended until the upper end of the conveyor is at the desired height, and production of firewood can begin. When it becomes time to relocate the machine around the jobsite, the operator does not need to change the position of the conveyor in any way. To relocate the machine, the operator needs to first check that the log lifter device is in its raised position. At this point, the rear foot can be retracted and the unit can be hitched to the towing vehicle by manually raising the front foot via rotation of the hand crank. The unit can then be towed to the new on-site location, unhitched from the vehicle, and immediately returned to operation. Therefore, the entire relocation process consists only of a single towing movement, and a single raising and lowering of each foot. The simplicity of this process results in a relocation time that is significantly less than the amount of time currently required to relocate two separate machines around the jobsite. The decreased stoppage time in the firewood production process results in a much more timely and efficient completion of one's firewood production job. In this way, the presently described invention holds a solution for the previously described inefficiency.

There are several other inherent advantages that the present, single-machine invention holds over the commonly utilized two-machine system. Firstly, as a single towable unit, the present invention requires the operator to make only one trip to the job site. With two separate towable machines, the operator must make two trips to the site, or otherwise have an additional truck and driver, as each standard vehicle cannot tow more than one trailer device. Making only one trip to the jobsite, rather than two, obviously offers significant savings in time and fuel expenditures. A second advantage that the presently described invention holds over the common two machine system lies in the fact that the single machine system is much more compact in nature than a common two-machine system. Not only does the increased compactness make the present invention much more maneuverable around tightly confined jobsites, but storing the system also becomes much easier. This is very evident when the time comes to transport the machine from the jobsite to the storage area, in that the conveyor component is manually pivoted around the hinge until it is returned to the position in which it rests on the same axle frame as the log splitter component. The result is that the present invention, while containing both a log splitter component and a conveyor component, requires approximately the same storage length as a conventional stand alone log splitter machine. The length, width, and height of the present invention are approximately the dimensions of a standard automobile, and therefore the entire invention can be stored easily in a homeowner's garage or shed. Therefore the compact nature of the present invention offers an advantage over current art, in that storing two separate machines is tedious, and requires significantly more space than that which is required by the present invention.

### BRIEF DESCRIPTION OF THE SEVERAL VIEWS OF THE DRAWINGS

FIG. 1 is a top plan of the present invention, depicting the machine in its stationary, but non-operational state.

FIG. 2 is a right side elevation of the machine, depicting the machine in its stationary, but non-operational state.

FIG. 3 is a front elevation of the present invention, depicting the machine in its stationary, but non-operational state.

FIG. 4 is a rear elevation of the present invention, depicting the machine is its stationary, but non-operational state.

FIG. 5 is a top plan of the machine, corresponding in orientation to FIG. 1, showing the pivoting motion of the conveyor apparatus from its non-operational position to its operational position. An enlarged schematic of the typical wood splitting operation is also provided.

FIG. 6 is a right side elevation of the machine, corresponding in orientation to FIG. 2, showing the machine in its operational position, as well as demonstrating the available range of conveyor height. The figure also depicts the available motions of the splitting head, and the telescoping rear foot. A magnified view of the control panels is also provided.

FIG. 7 is a cross-section taken along line A-A of FIG. 6, depicting the motion of the log lifter device during the wood splitting operation. A magnified view of the control panels is also provided.

FIG. 8 is a left side elevation of the machine, showing the machine in its operational position. The figure also depicts the available motions of the splitting head, and the telescoping rear foot. A magnified view of the control panels is also provided.

FIG. 9 is a mechanical schematic diagramming the transmission of hydraulic throughout all power-driven systems of the machine. This diagram is meant to be viewed simultaneously with FIGS. 5, 6, 7, and 8 so as to aid the reader in the accurate interpretation of these drawings.

FIG. 10 is a right side elevation of the machine, corresponding in orientation to FIGS. 1 and 6, depicting the state in which the machine can be relocated around the jobsite.

FIG. 11 is a left side elevation of the present invention, depicting the machine state in which the machine can be transported on public roads and highways.

### DETAILED DESCRIPTION OF THE INVENTION

The construction and operation of the present invention is herein described in a manner which corresponds to the progression of the attached drawings.

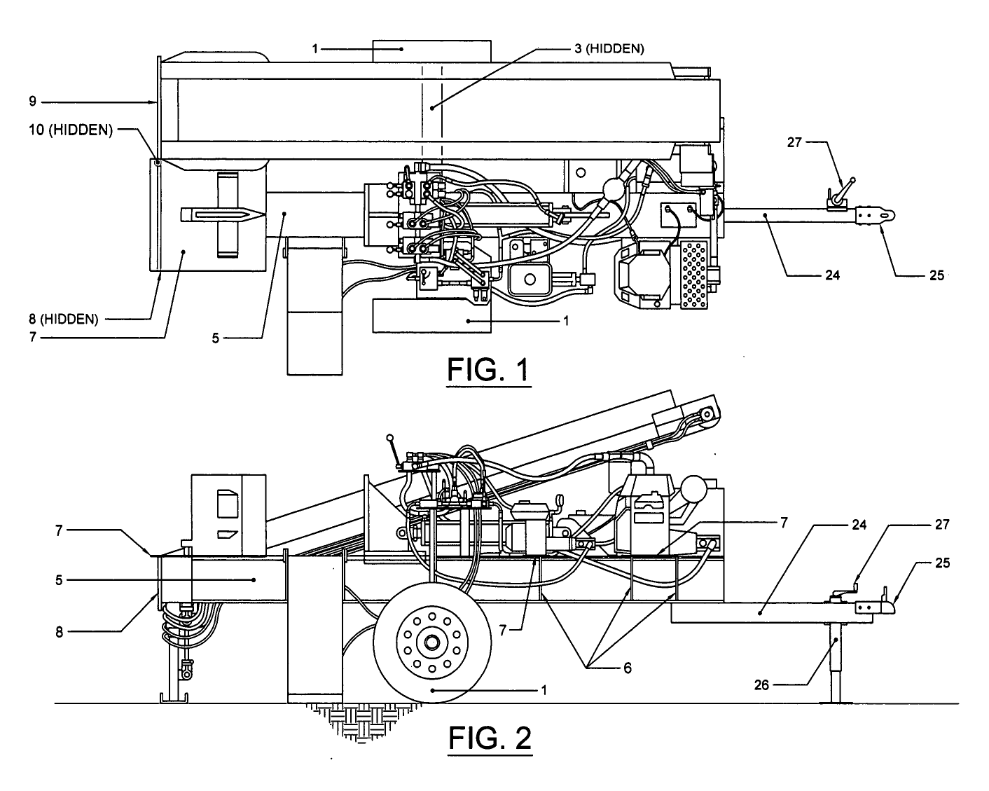

In reference to FIGS. 1, 2, 3, and 4, the development of the present invention begins with a pair of wheels 1, linked to one another by an axle which is housed in axle sleeve 2. Axle support beam 3 is then welded to the axle sleeve along its entire length, so as to provide a rigid and square connection point for the framework of the machine. Steel spacer 4 is welded to the top of axle support beam 3, and it is upon this spacer that steel I-beam 5 is centered and welded. Angle supports 6 are then welded to the bottom flange of steel I-beam 5, providing many additional support points for the subsequent welded attachment of steel plates 7. The combination of these steel plates and the top flange of steel I-beam 5, provides the supported surface upon which all the components of the horizontally oriented log splitter system are mounted. Steel face plate 8 is welded to the rear end of steel I-beam 5, and is joined to steel face plate 9, by hinge 10. Steel faceplate 8 features bolt hole 11, while steel faceplate 9 features bolt hole 12. Bolt holes 11 and 12 are located at the same elevation and at identical distances from hinge 10. Steel sleeve 13 is welded to the front of face plate 9, and steel pin 14 is inserted into sleeve 13, so as to join conveyor track rails 15 to face plate 9 in a way which permits the track rails to rotate around pin 14. Steel brace 16 is welded between conveyor track rails 15, to add support. Steel stirrups 17 are welded to the undersides of conveyor track rails 15. Steel conveyor legs 18 are then connected to stirrups 17 with bolted pins 19, so as to permit rotation of the legs beneath the conveyor frame. Steel brace 20 is welded between conveyor legs 18 for support. Axle rod 21 is then welded to the lower ends of conveyor legs 18, and conveyor wheels 22 are attached to the ends of said axle rod. The entire framework of the conveyor component rests, in a folded position, upon steel holding brackets 23, which are welded directly onto axle support beam 3. A portion of the top of steel box beam 24 is welded longitudinally to the bottom of steel I-beam 5, thus yielding a tongue, upon which a conventional trailer hitch receiver 25 is bolted. In addition, an extendable front foot 26 is also provided, along with hand crank 27, to allow for the conventional methods of unhitching and hitching the machine from a towing vehicle.

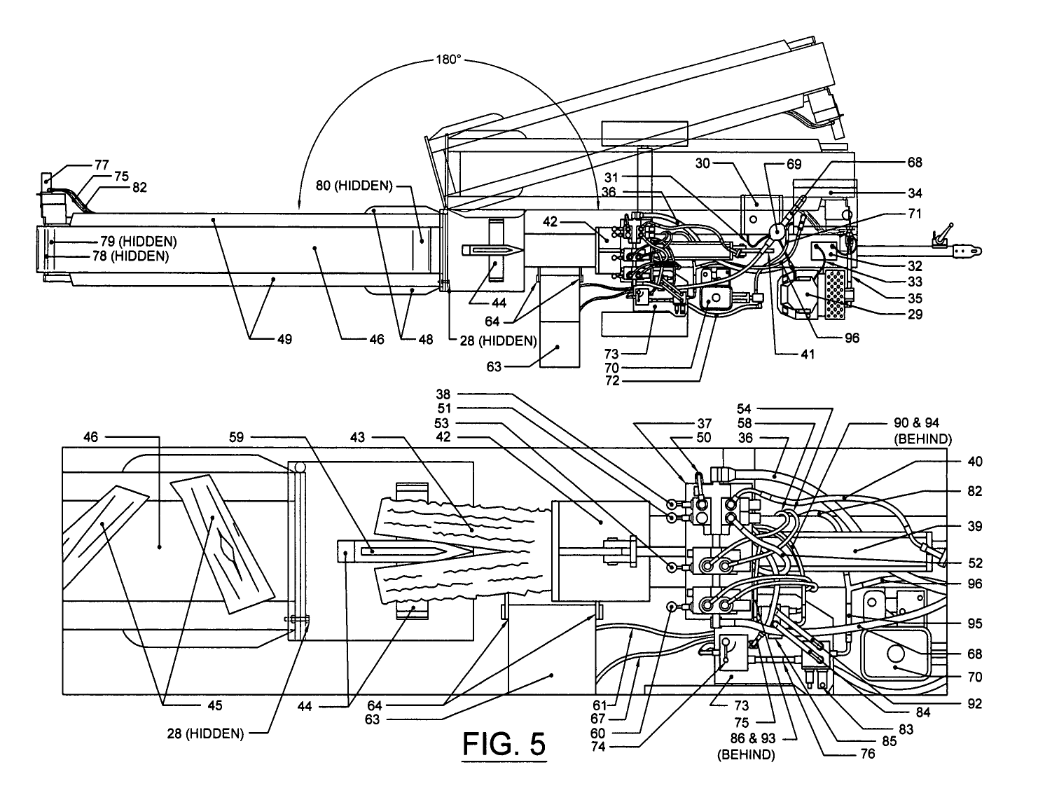

In order to make the machine operational for the production of firewood, the entire conveyor apparatus must pivot one hundred-eighty degrees around the hinge. This rotation causes the lower end of the conveyor to become adjacent to the splitting head at the rear end of the log splitter. With reference to FIG. 5, the rotation of the conveyor from resting position to operational position must be performed manually. However, this action does not require the operator to exert much physical force, simply because the entire conveyor frame acts as a lever arm for its own rotation around the hinge. Once the conveyor has been fully rotated into operational position, the operator can then lock the conveyor in place. This is done by manually inserting bolt 28 through the now aligned bolt holes of the faceplates, and fastening with a nut. At this point, the conveyor legs assembly can be lowered to the ground for support, and the systematic production of firewood can begin.

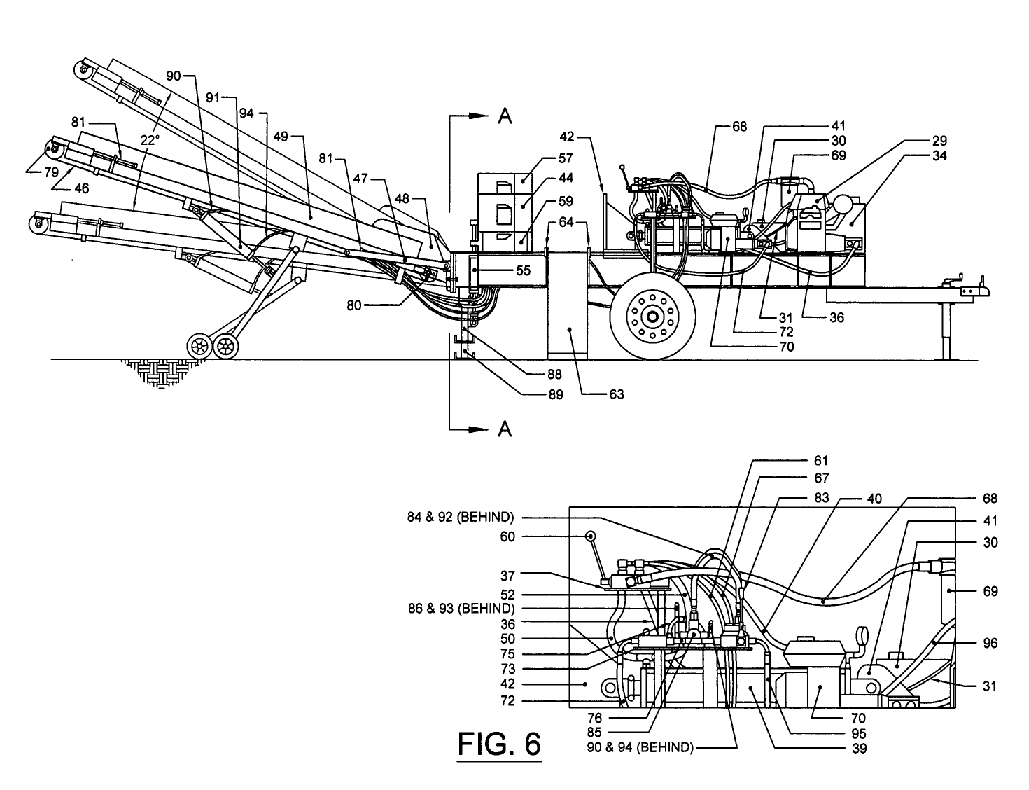

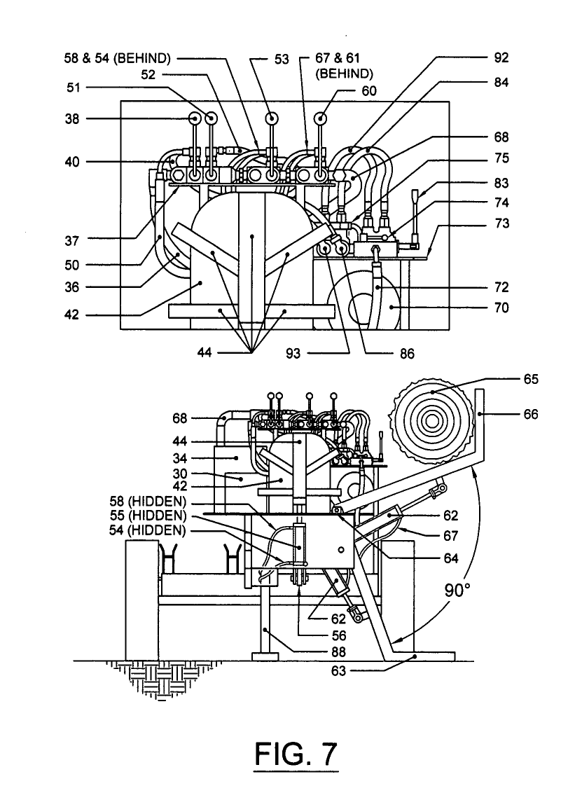

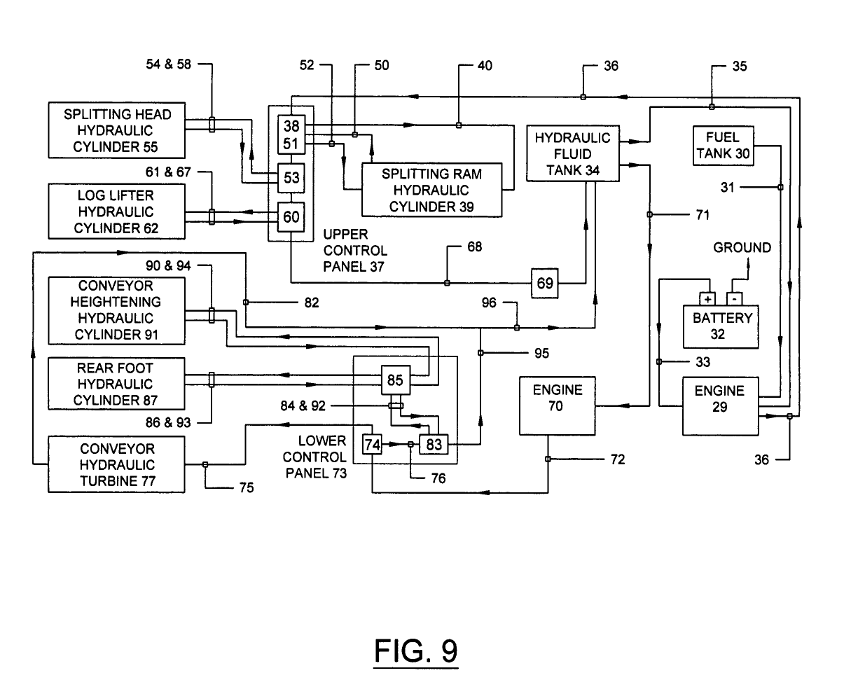

Referring now to FIGS. 5, 6, 7, 8, and 9, the log splitter system begins with engine 29 which draws fuel from gasoline tank 30 through supply line 31. The internal combustion of engine 29 is triggered by battery 32 through positive ignition wire 33. All power produced by said engine is used to pressurize hydraulic fluid which is drawn from hydraulic fluid tank 34 to the hydraulic pump in engine 29, via supply line 31. Once pressurized, the hydraulic fluid is directed through supply line 36 to upper control panel 37.

From this point, the pressurized fluid is used to force the motions of all hydraulic cylinders that are governed by the various levers mounted upon upper control panel 37. The first of these levers is control lever 38, the forward rotation of which, forces pressurized fluid into the rear of hydraulic cylinder 39, through supply line 40. The input of hydraulic fluid into the rear of hydraulic cylinder 39 causes it to extend. The rear of hydraulic cylinder 39 is fixed to rigid steel flange 41 which is in turn welded directly to the steel I-beam of the log splitter. The front of hydraulic cylinder 39 is attached to splitting ram 42. Therefore, as hydraulic cylinder 39 extends, splitting ram 42 is advanced through the splitting zone. Assuming, as would typically be the case, that a log section 43 is occupying said splitting zone, then the forward advancement of splitting ram 42 forces log section 43 forward through the blades of splitting head 44. Log section 43 is forced continually forward until splitting ram 42 makes contact with splitting head 44, at which point, log section 43 will have been completely split into smaller firewood pieces 45, which in turn, fall directly onto conveyor belt 46. Due to the high level of operational stress experienced by the lower end of the conveyor, steel struts 47 are provided for additional support and bracing. Struts 47 are pin connected at one end to the faceplate of the conveyor, and are pin connected at the other end to the conveyor track rails. Angled steel plates 48 are welded to the conveyor track rails so as to ensure that all falling pieces of firewood are caught by the conveyor as they exit the vicinity of the splitting head. Steel guard rails 49 are also welded to the conveyor track rails, and extend for the entire length of the conveyor, so as to ensure that all firewood pieces remain on conveyor belt 46 until they have reached the uppermost extent of said belt, where they are then deposited on the ground below.

At this point, splitting ram 42, having reached its furthest extent, needs to be retracted so as to permit the splitting of another log section. This task can be accomplished by the rearward rotation of control lever 38, which causes pressurized hydraulic fluid to flow through supply line 50, into the front of hydraulic cylinder 39. This input of fluid forces hydraulic cylinder 39 to retract, thereby causing splitting ram 42 to also retract to its original position. Hydraulic cylinder 39 is of the modern position-sensing type. Therefore, an additional control lever 51 is provided, along with supply line 52, which tees into supply line 50 at the front of hydraulic cylinder 39. This configuration allows the operator to give a single command which causes hydraulic cylinder 39 to extend, but immediately begin retracting once the splitting ram has made contact with the splitting head. This command is given by the simultaneous forward rotation of both control levers 38 and 51. Hydraulic cylinder 39, while featuring modern position-sensing technology, is largely based on a conventional double-acting hydraulic cylinder design. Therefore, as hydraulic cylinder 39 extends due to the input of pressurized hydraulic fluid from line 40, hydraulic fluid in the front portion of the cylinder is forced out of the cylinder and back to upper control panel 37, through line 50. Line 40, in this case, acts as the supply line while line 50 assumes the role of return line. In the event that hydraulic cylinder 39 is caused to retract due to the input of fluid from either line 50 or line 52, then line 40 will assume the role of return line as hydraulic fluid is forced out of the rear portion of the cylinder and back to the upper control panel.

Pressurized fluid from the upper control panel is also drawn into the housing of lever 53. Rotating lever 53 forward causes pressurized hydraulic fluid to flow through supply line 54 into the bottom of splitting head hydraulic cylinder 55, thereby forcing the hydraulic cylinder to extend upward. The bottom of hydraulic cylinder 55 is fixed to rigid steel flange 56 which is in turn welded to the steel I-beam of the log splitter. The top of hydraulic cylinder 55 is screwed into splitting head 44. Therefore, as hydraulic cylinder 55 extends upwards, splitting head 44 is raised to a higher position 57, thereby achieving a better alignment between the center of said splitting head and the center of a log section which may feature an unusually large diameter. This makes for more effective splitting of such log sections, while also decreasing the amount of torsional stress on the entire machine. Rotating lever 53 backwards forces pressurized hydraulic fluid through supply line 58, and into the top of splitting head hydraulic cylinder 55. This action causes the hydraulic cylinder to retract, thus lowering splitting head 44 back to its original position. The action of raising and lowering splitting head 44 is made possible because of the fact that the splitting head itself is not directly connected to any part of the log splitter frame. Instead, splitting head 44 encases a high-strength steel core 59 which is essentially a thick flange, welded directly to the steel I-beam of the log splitter. Therefore, as hydraulic cylinder 55 extends, splitting head 44 slides upwards along a portion of the steel core. Regardless of its position, splitting head 44 transmits all force received from a log section directly to steel core 59, which in turn, transmits said force to the steel I-beam of the log splitter. The rigid material and construction of the splitting head apparatus permits the successful splitting of log sections which may contain many knots or other unusually hard abnormalities.

Hydraulic cylinder 55 is of the conventional double-acting type. Therefore, as hydraulic cylinder 55 extends due to the input of pressurized hydraulic fluid from line 54, hydraulic fluid in the top portion of the cylinder is forced out of the cylinder and back to upper control panel 37, through line 58. Line 54, in this case, acts as the supply line while line 58 assumes the role of return line. In the event that hydraulic cylinder 55 is caused to retract due to the input of fluid from line 58, then line 54 will assume the role of return line as hydraulic fluid is forced out of the bottom portion of the cylinder and back to the upper control panel.

The last lever on the upper control panel is lever 60. The housing of lever 60 also draws pressurized fluid from the upper control panel. Rotating lever 60 forward causes pressurized hydraulic fluid to flow through supply line 61 into the top of log lifer hydraulic cylinder 62, thereby causing hydraulic cylinder 62 to extend downwards. The upper extent of said hydraulic cylinder 62 is pin connected to the side of the steel I-beam of the log splitter, while the lower extent is pin connected to the bottom of log lifter 63. Log lifter 63 is, in turn, pin connected to the steel I-beam of the log splitter through brackets 64. Therefore the entire log lifter device, including hydraulic cylinder 62, is made to rotate upwards as hydraulic fluid pressure forces the cylinder to extend. The log lifter itself is L-shaped, allowing for a log section 65 to be rolled into the corner of the L-shape, before the rotation begins. As the log lifter rotates upwards, log section 65 is consequently carried upwards. Once the log lifter reaches its uppermost position 66, log section 65 will, through the force of gravity, roll down the incline of the log lifter, and into the splitting zone. At this point, lever 60 can be rotated backwards, thereby directing pressurized hydraulic fluid through supply line 67. Pressurized hydraulic fluid then enters the bottom of log lifter hydraulic cylinder 62, causing the cylinder to retract. The retraction of hydraulic cylinder 62 causes the log lifter apparatus to rotate downwards, thus returning the log lifter to a position in which another log section can then be loaded.

Hydraulic cylinder 62 is of the conventional double-acting type. Therefore, as hydraulic cylinder 62 extends due to the input of pressurized hydraulic fluid from line 61, hydraulic fluid in the bottom portion of the cylinder is forced out of the cylinder and back to upper control panel 37, through line 67. Line 61, in this case, acts as the supply line while line 67 assumes the role of return line. In the event that hydraulic cylinder 62 is caused to retract due to the input of fluid from line 67, then line 61 will assume the role of return line as hydraulic fluid is forced out of the top portion of the cylinder and back to the upper control panel.

The hydraulic pump in engine 29 is constantly forcing the cyclical motion of hydraulic fluid from the hydraulic fluid tank, through the various supply lines, and finally back to the hydraulic fluid tank. The constant cycle of this process means that all parts of the hydraulic system are constantly pressurized, and that therefore hydraulic fluid is forced to return to the hydraulic fluid tank at the same rate that fluid is leaving the tank. After being made available for use in all hydraulic cylinders governed by the upper control panel, all hydraulic fluid from said upper control panel is returned to hydraulic fluid tank 34 through return line 68, wherein all hydraulic fluid passes through filter 69 to ensure cleanliness.

The conveyor system begins with engine 70 which is supplied with a built-in fuel tank and a standard pull-start mechanism. Hydraulic fluid is drawn from hydraulic fluid tank 34 into the pump of engine 70 through supply line 71. The pump in engine 70 accomplishes the task of pressurizing all hydraulic fluid from supply line 71, and then directing all pressurized hydraulic fluid through supply line 72 to lower control panel 73. Once reaching lower control panel 73, all pressurized hydraulic fluid enters the housing of control lever 74. With control lever 74 in the position shown, pressurized hydraulic fluid is output into both supply line 75 and supply line 76. Supply line 75 carries pressurized hydraulic fluid to conveyor turbine 77, wherein said turbine manipulates the pressurized stream of hydraulic fluid in such a way as to force the rotation of driveshaft 78. Driveshaft 78 is housed by and attached to upper spindle 79. Therefore, rotation of driveshaft 78 causes the subsequent rotation of upper spindle 79. As upper spindle 79 rotates, conveyor belt 46 is caused to rotate, as said conveyor belt is wrapped around upper spindle 79 and lower spindle 80. Conveyor belt 46 is held taught between spindles 79 and 80 by adjustable tensioner bolts 81. After powering the motion of conveyor turbine 77, all hydraulic fluid is directed through return line 82. If no conveyor motion is desired, such as during periods of pivoting the conveyor, then control lever 74 can be rotated into its alternate position, thereby causing all pressurized hydraulic fluid to flow into supply line 76.

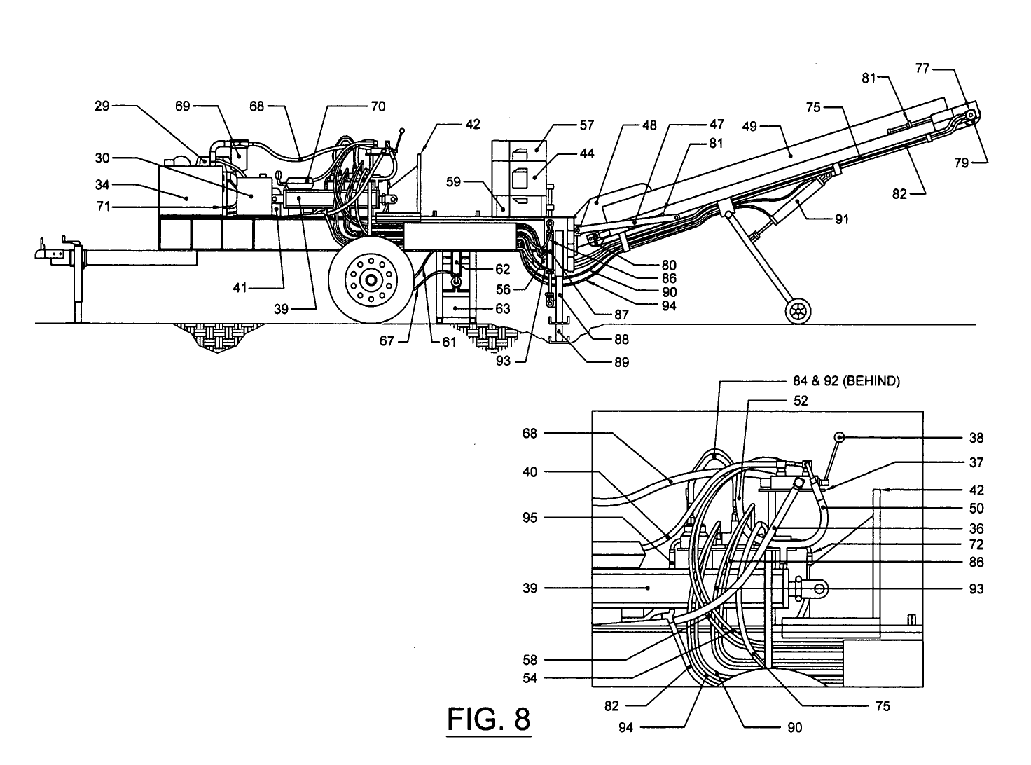

Regardless of the position of control lever 74, supply line 76 constantly carries pressurized hydraulic fluid to the housing of control lever 83. The forward rotation of control lever 83, causes pressurized hydraulic fluid to flow through supply line 84 into the housing of switch 85. When in its first position, switch 85 directs all hydraulic fluid from supply line 84 into supply line 86. Pressurized hydraulic fluid flows through supply line 86 into the top of rear foot hydraulic cylinder 87, thereby causing hydraulic cylinder 87 to extend downwards. The top end of hydraulic cylinder 87 is fixed to the steel I-beam of the log splitter, whilst the bottom end is connected to telescoping rear foot 88. Therefore, as hydraulic cylinder 87 extends downwards, telescoping rear foot 88 is forced to extend downwards, until said foot has reached its stationary support position 89. The adjustable height of this foot provides the operator with the advantage of being able to maintain a level log splitting surface, even if the machine is located on sloping ground, as shown in FIG. 8. Alternatively, if switch 85 is in its second position, then all pressurized hydraulic fluid from supply line 84 must flow into supply line 90. Pressurized hydraulic fluid flows through supply line 90 into the top of conveyor heightening hydraulic cylinder 91, thereby causing hydraulic cylinder 91 to extend downwards. The top end of hydraulic cylinder 91 is pin connected to the cross brace of the conveyor frame, while the bottom end is pin connected to the cross brace of the wheeled conveyor legs assembly. Therefore, as hydraulic cylinder 91 extends downwards, the conveyor legs are forced to rotate inwards. As the angle of the conveyor's legs increases, the angle of the conveyor frame must increase accordingly, thus heightening the uppermost extent of conveyor belt 46. In this way, the operator can continually increase the height of the conveyor so as to accommodate for the increasing height of the firewood pile below the conveyor.

The rearward rotation of control lever 83 causes the reverse processes to occur. The reverse processes begin with all pressurized hydraulic fluid now being directed into supply line 92, and no longer into supply line 84. Supply line 92 carries the pressurized hydraulic fluid to the housing of switch 85, wherein switch 85, if in its first position, directs all pressurized hydraulic fluid through supply line 93, into the bottom of rear foot hydraulic cylinder 87, causing the hydraulic cylinder to retract. Consequently, the telescoping hydraulic foot retracts, rising away from its stationary support position and into a transportable position. Alternatively, if switch 85 is in its second position, then all pressurized hydraulic fluid from supply line 92 must flow into supply line 94. Pressurized hydraulic fluid flows through supply line 94 into the bottom of conveyor heightening hydraulic cylinder 91, thereby causing hydraulic cylinder 91 to retract upwards. Consequently, the conveyor legs are forced to rotate outwardly. As the angle of the conveyor's legs decreases, the angle of the conveyor frame must decrease accordingly, thus lowering the upper end of the conveyor.

Hydraulic cylinders 87 and 91 are both of the conventional double-acting type. Therefore, as hydraulic cylinder 87 extends due to the input of pressurized hydraulic fluid from line 86, hydraulic fluid in the bottom portion of the cylinder is forced out of the cylinder and back to lower control panel 73, through line 93. Line 86, in this case, acts as the supply line while line 93 assumes the role of return line. In the event that hydraulic cylinder 87 is caused to retract due to the input of fluid from line 93, then line 86 will assume the role of return line as hydraulic fluid is forced out of the top portion of the cylinder and back to the lower control panel. Similarly, as hydraulic cylinder 91 extends due to the input of pressurized hydraulic fluid from line 90, hydraulic fluid in the bottom portion of the cylinder is forced out of the cylinder and back to lower control panel 73, through line 94. Line 90, in this case, acts as the supply line while line 94 assumes the role of return line. In the event that hydraulic cylinder 91 is caused to retract due to the input of fluid from line 94, then line 90 will assume the role of return line as hydraulic fluid is forced out of the top portion of the cylinder and back to the lower control panel.

The hydraulic pump in engine 70 is constantly forcing the cyclical motion of hydraulic fluid from the hydraulic fluid tank, through the various supply lines, and finally back to the hydraulic fluid tank. The constant cycle of this process means that all parts of the hydraulic system are constantly pressurized, and that therefore hydraulic fluid is forced to return to the hydraulic fluid tank at the same rate that fluid is leaving the tank. After being made available for use in all hydraulic devices governed by the lower control panel, all hydraulic fluid from said lower control panel is directed through return line 95. Return line 95 tees into conveyor turbine return line 82, and the two form return line 96, which carries all hydraulic fluid back to hydraulic fluid tank 34.

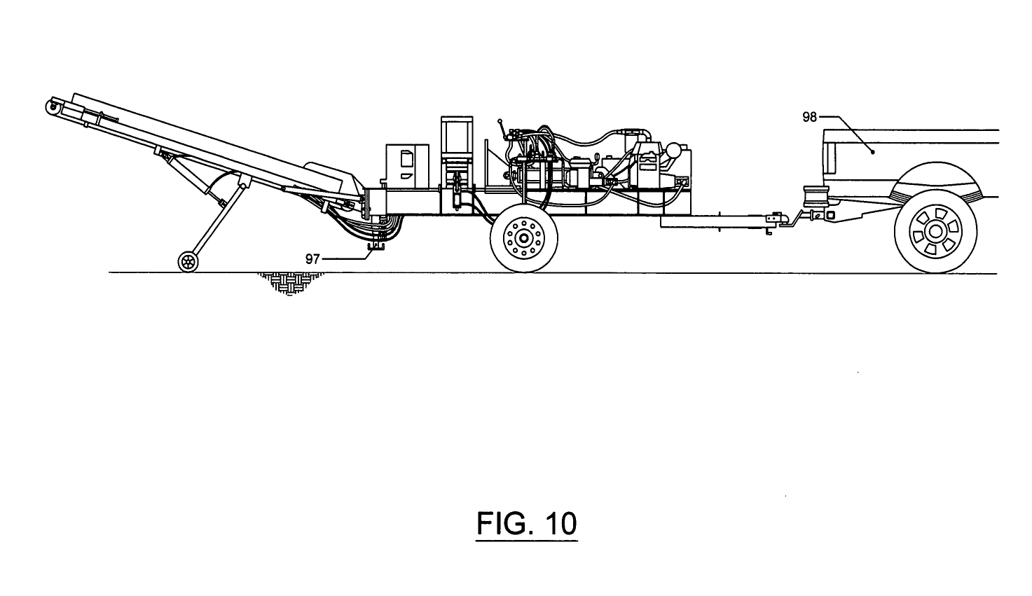

With reference to FIG. 10, when the time comes to relocate the machine short distances around the jobsite, three steps need to be taken. First, the operator needs to rotate the control lever of the log lifter hydraulic cylinder in such a way as to raise the log lifter to its uppermost position. Next, the operator needs to rotate the control lever of the rear foot hydraulic cylinder, so as to retract the telescoping rear foot to its uppermost position 97. Lastly, the unit can be hitched to the towing vehicle 98 by positioning the vehicle and then manually lowering the tongue of the machine until the receiver becomes set upon the ball of the hitch. This is accomplished through the rotation of the hand crank on the front foot. The front foot is then manually rotated ninety-degrees counterclockwise and locked onto the side of the tongue, as is conventional.

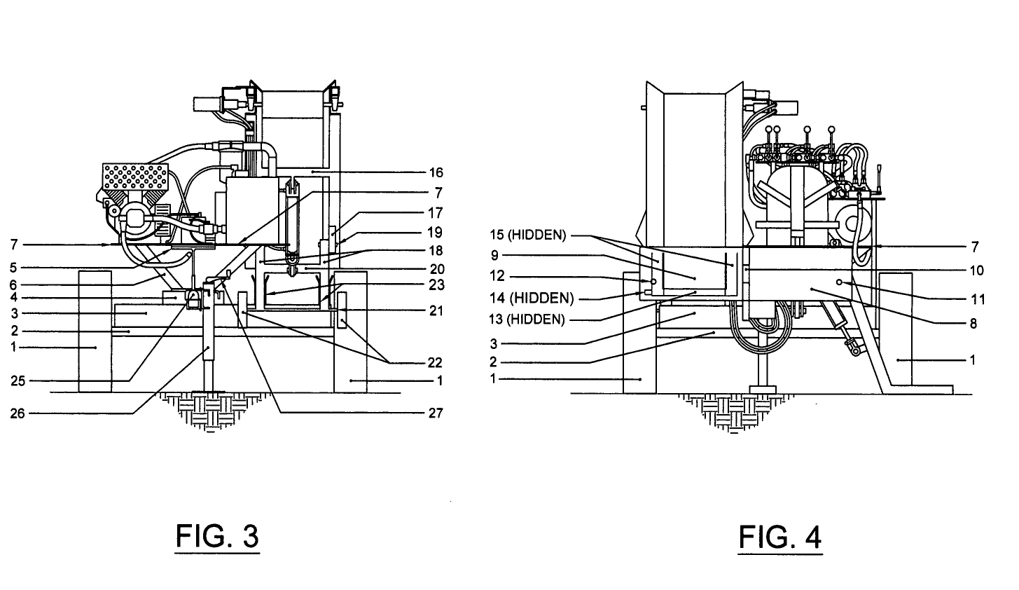

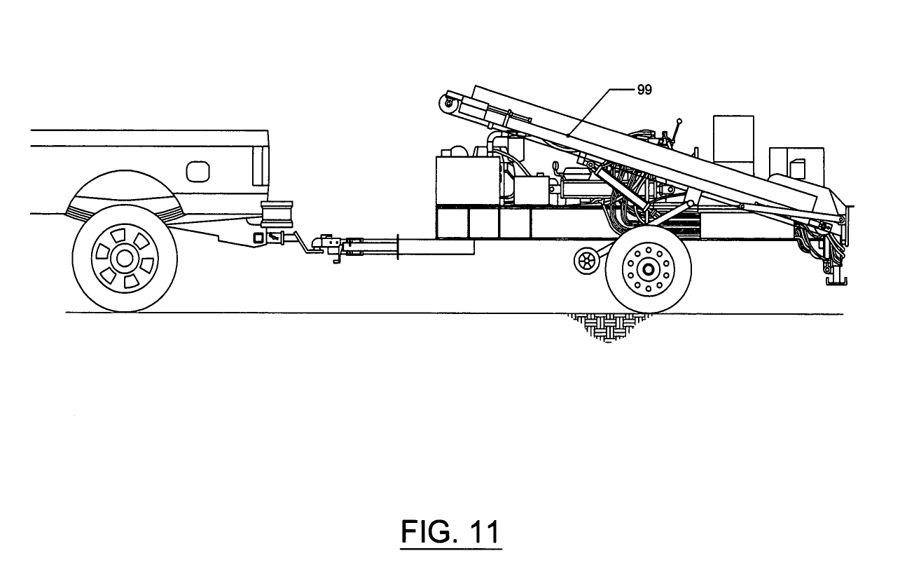

With reference to FIG. 11, when the time comes to transport the machine to a new jobsite, or to haul the machine on a roadway, four further steps need to be taken in addition to those previously described with reference to FIG. 10. With the smaller engine running, the operator must first rotate the control lever of the conveyor lifting hydraulic cylinder in such a way as to cause the legs of the conveyor mechanism to rise up off the ground. Next, the locking bolt must be manually removed from the faceplates, allowing for the free rotation of the conveyor apparatus about the hinge. Thirdly, the operator needs to manually pivot the conveyor apparatus around the hinge into its transportable position 99. Lastly, the operator must lock the conveyor apparatus into this transportable position by again rotating the control lever of the conveyor lifting hydraulic cylinder in such a way as to cause the slight lowering of the legs assembly until both legs rest in their respective leg holders, previously described with reference to FIG. 3. The smaller engine can then be cut off, and transportation can commence.

The description and corresponding illustrations presented herein clearly explain the preferred embodiment of the present invention. However, it must be understood that the present invention is not to be limited to the exact construction and operation depicted above, but shall include all reasonable modifications and variations which fall within the scope and spirit of the specified claims.

1. I claim in a horizontally oriented log splitter machine comprising:
a set of wheels connected by an axle;
a hydraulic splitting ram;
a splitting head;
a steel support frame comprising a steel trailer tongue, a steel I-beam, a steel axle sleeve, two steel holding brackets, and an axle support beam which has a first end, a second end, a first half corresponding to the first end, and a second half corresponding to the second end;
an engine which pressurizes hydraulic fluid for the purpose of forcing the splitting ram forward, thereby driving log sections through the splitting head; and
a conveyor mechanism comprising a rubber track which moves continuously around an upper spindle and a lower spindle, an engine which pressurizes hydraulic fluid for the purpose of diverting said fluid through a hydraulic turbine attached to the upper spindle, a steel faceplate, two steel track rails which separate the spindles from one another, and pair of support legs which have first ends supplied with wheels, and second ends at which said legs are pin-connected to said track rails.

2. In the log splitter of claim 1, wherein the bottom of said axle support beam is welded, along its entire length, to the top of said axle sleeve.

3. In the log splitter of claim 1, wherein said structural steel I-beam is positioned perpendicular to, and centered on top of the first half of said axle support beam.

4. In the log splitter of claim 1, wherein said holding brackets are welded onto the top of the second half of said axle support beam, providing elevated locations for said support legs of said conveyor mechanism to rest, suspended from the ground, when said conveyor mechanism is in its non-operational position.

5. In the log splitter of claim 1, wherein said steel trailer tongue is welded to, and extends out from said structural steel I-beam, providing a single point from which the machine may be towed by a vehicle.

6. I claim in a horizontally oriented log splitter machine comprising:
a set of wheels connected by an axle;
a hydraulic splitting ram;
a splitting head;
a steel support frame comprising a steel trailer tongue, a steel faceplate, and a structural steel I-beam which has a first end, a second end, a bottom flange to which the trailer tongue is welded close to said first end, and a top flange, upon which the splitting head is mounted close to said second end;
an engine which pressurizes hydraulic fluid for the purpose of forcing the splitting ram forward, thereby driving log sections through the splitting head; and
a conveyor mechanism comprising a rubber track which moves continuously around an upper spindle and a lower spindle, an engine which pressurizes hydraulic fluid for the purpose of diverting said fluid through a hydraulic turbine attached to the upper spindle, a steel faceplate, two steel track rails which have first ends corresponding to the location of the lower spindle, and second ends corresponding to the location of the upper spindle, and pair of support legs which have first ends supplied with wheels, and second ends at which said legs are pin-connected to said track rails.

7. In the log splitter of claim 6, wherein said faceplate of said support frame is welded to the cross section of the second end of said steel I-beam, and said faceplate of said conveyor mechanism is pin-connected to said track rails at the first ends of said track rails.

8. In the log splitter of claim 7, wherein said conveyor mechanism is permanently attached to said steel support frame, by means of connection, at only one point; said point being located between said faceplate of the support frame and said faceplate of the conveyor mechanism.

9. In the log splitter of claim 8, wherein said means of connection is comprised of a single hinge, thus enabling said conveyor mechanism to be pivoted from its non-operational position to its operational position, thereby causing said faceplate of the support frame to become flush against said faceplate of the conveyor mechanism.

10. In the log splitter of claim 9, wherein said faceplate of said conveyor mechanism has a bolt hole near its outer edge, and said faceplate of said support frame has a bolt hole near its outer edge.

11. In the log splitter of claim 10, wherein the rotation of said conveyor mechanism, from its non-operational position to its operational position, causes said bolt hole of said faceplate of the support frame to become aligned with the bolt hole of said faceplate of the conveyor mechanism.

12. In the log splitter of claim 11, wherein said face plate of the support frame is supplied with a bolt and nut, wherewith said face plate of said support frame may be bolted to said face plate of the conveyor mechanism, by the insertion of said bolt through said aligned bolt holes, thereby temporarily locking said conveyor mechanism in its operational position.

13. In the log splitter of claim 6, wherein the support legs of said conveyor mechanism are supplied with a hydraulic armature, which through extension, lowers said support legs of said conveyor mechanism until the wheels of said support legs have made contact with the ground, thereby providing support for the conveyor mechanism while the machine is in its operational position.

14. In the log splitter of claim 6, wherein said support frame further comprises a telescoping rear foot and an extendable front foot, both of which are extended during periods of firewood production, so as to supplement the wheels of the conveyor support legs and the wheels of the support frame in providing additional points of support.

15. In the log splitter of claim 14, wherein said extendable front foot and said telescoping rear foot are capable of retracting, consequently leaving the two wheels of the support frame and the two wheels of the conveyor support as the only points of contact between the log splitter and the ground, thus enabling the machine to be towed while in its operational position.
